(19) United States
(12) Patent Application Publication
(10) Pub. No.: US 2025/0301306 A1
(43) Pub. Date: Sep. 25, 2025

(54) DYNAMIC WIRELESS NETWORK PROTOCOLS

(71) Applicant: T-MOBILE INNOVATIONS LLC, Overland Park, KS (US)

(72) Inventors: Zheng CAI, Fairfax, VA (US); Jun LIU, Sammamish, VA (US)

(21) Appl. No.: 18/611,033

(22) Filed: Mar. 20, 2024

(51) Int. Cl. H04W 8/22

(52) U.S. Cl. CPC H04W 8/22

(57) ABSTRACT

Systems and methods are provided for utilizing dynamic wireless network protocols. A user equipment (UE) capability message is received from a UE at a node indicating a type of the UE. Based on the type of UE, the node determines a dynamic wireless network protocol specific to the type of UE.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for utilizing dynamic wireless network protocols. A user equipment (UE) capability message is received from a UE at a node indicating a type of the UE. The type of UE may comprise one of: a home customer premises equipment (CPE), a fixed internet of things (IoT) sensor, an Ultra-Reliable Low Latency Communications (URLLC) device, or a 6G device. Based on the type of UE, the node determines a dynamic wireless network protocol specific to the type of UE.

For example, the dynamic wireless network protocol may comprise local authentication only. In another example, the dynamic wireless network protocol may comprise signaling only and no user plane or mobility within the core network. In yet another aspect, the dynamic wireless network protocol may comprise no Hybrid Automatic Repeat Request (HARQ). In another example, the dynamic wireless network protocol may comprise no radio link control (RLC) acknowledge mode (AM).

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an example of a network environment in which implementations of the present disclosure may be employed;

FIG. 2 depicts examples of a static call flow and a dynamic call flow, in accordance with aspects herein;

FIG. 3 depicts examples of a static protocol stack and a dynamic protocol stack, in accordance with aspects herein;

FIG. 4 depicts a flow diagram of an example method for utilizing dynamic wireless network protocols; and

FIG. 5 depicts a diagram of an exemplary computing environment suitable for use in implementations of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Signal Receive Power
RSRQ Reference Signal Receive Quality
RSSI Received Signal Strength Indicator
SINR Signal-to-Interference-Plus-Noise Ratio
SNR Signal-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 32nd Edition (2022).

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an eNodeB). In this regard, typically only one active uplink connection can occur per frequency. The base station may include one or more sectors served by individual transmitting/receiving components associated with the base station (e.g., antenna arrays controlled by an eNodeB). These transmitting/receiving components together form a multi-sector broadcast arc for communication with mobile handsets linked to the base station.

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service.

The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network.

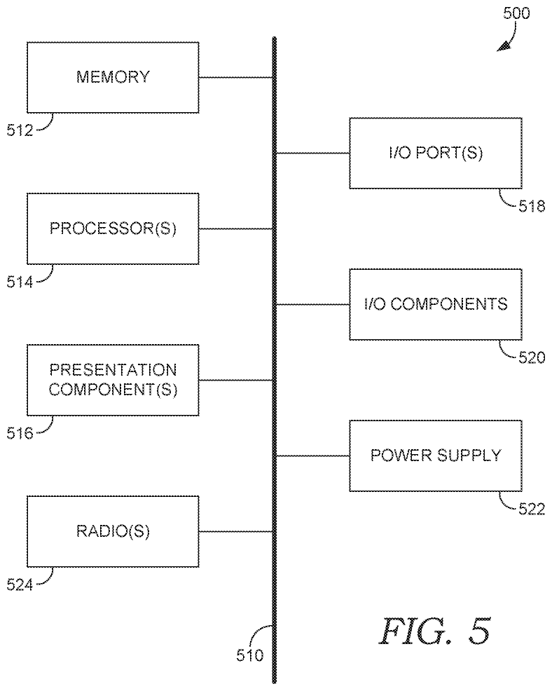

For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point. A UE may be, in an embodiment, similar to device 500 described herein with respect to FIG. 5.

In conventional cellular communications technology, wireless network protocol stacks have never been changed or modified. The overall architecture has been designed as basically having three domains: access, transport, and core. This architecture generally works well as designed for mobile communications. Recently, fixed wireless services have evolved out of 5G. Fixed wireless services do not have mobility requirements. Moreover, 6G advancements may yield virtual reality, holographic communications, and the like, which may require extremely high application speeds, low mobility, low latency, and/or high reliability. In these fixed or very low mobility environments, the core network may not be needed as it is designed to facilitate mobility.

The present disclosure is directed to significantly reducing the cost for the mobile operators by utilizing dynamic wireless network protocols. In particular, the 6G radio access network (RAN) architecture can be reduced in many instances. Since the core network is not needed for all applications, mobile operators can significantly reduce core network costs. To do so, a parameter can be set in the UE capability message to indicate a type of UE. For example, if the UE is a fixed, non-mobile UE, such as home CPE or if the UE is a fixed, non-mobile sensor such as an IoT sensor, the node will dynamically execute different protocols stacks. For example, if the UE is a home CPE, the node will execute local authentication and a simplified protocol stack, where there is no signaling and no user plane in the core network. In contrast, if the UE is a fixed IoT sensor, the node will execute local authentication and a simplified protocol stack, where there is only signaling but no user plane in the core network. In some aspects, the node may select different waveforms based on type of UE. In this way, the core network can largely be bypassed which reduces the network complexity, shortens the processing time, reduces latency, and saves energy consumption. Moreover, the 6G RAN can be a user centric network rather than a node controlled network.

In a first aspect of the present invention, computer-readable media is provided, the computer-readable media having computer-executable instructions embodied thereon that, when executed, perform a method of utilizing dynamic wireless network protocols. The method comprises receiving, at a node, a user equipment (UE) capability message from a UE indicating a type of the UE. The method also comprises, based on the type of UE, determining, at the node, a dynamic wireless network protocol specific to the type of UE.

A second aspect of the present disclosure is directed to a method of utilizing dynamic wireless network protocols. The method comprises receiving, at a node, a user equipment (UE) capability message from a UE indicating a type of the UE. The method also comprises, based on the type of UE, determining, at the node, a dynamic wireless network protocol specific to the type of UE.

Another aspect of the present disclosure is directed to a system for utilizing dynamic wireless network protocols. The system comprises a user equipment (UE); and a node configured to wirelessly communicate with the UE. The node is configured to: receive a UE capability message from a UE indicating a type of the UE; based on the type of UE, determining a dynamic wireless network protocol specific to the type of UE; and initiate the dynamic wireless network protocol specific to the type of UE.

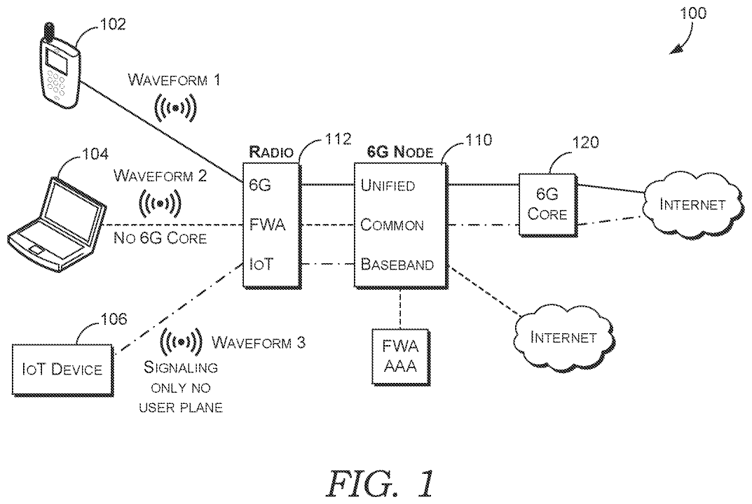

FIG. 1 depicts a wireless network environment incorporating dynamic wireless network protocols in which implementations of the present disclosure may be employed. Such a network environment is illustrated and designated generally as network environment 100. Network environment 100 is not to be interpreted as having any dependency or requirement relating to any one or combination of components illustrated.

Network environment 100 includes user devices (UEs) 102, 104, 106, node 110, (which may be a cell site, base station, or the like), and core network 120. In network environment 100, user device may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device) that communicates via wireless communications with the node 110 in order to interact with a public or private network.

In some aspects, UE(s) 102, 104, 106 may correspond to computing device 500 in FIG. 5. Thus, a UE can include, for example, a display(s), a power source(s) (e.g., a battery), a data store(s), a speaker(s), memory, a buffer(s), a radio(s) and the like. In some implementations, for example, a UE(s) 102, 104, 106 may comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, LTE, CDMA, or any other type of network.

In some cases, UE(s) 102, 104, 106 in network environment 100 can optionally utilize one or more communication channels to communicate with other computing devices (e.g., a mobile device(s), a server(s), a personal computer(s), etc.) through node 110. The network environment 100 may be comprised of a telecommunications network(s), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

The one or more communication channels can be part of a telecommunication network that connects subscribers to their immediate telecommunications service provider (i.e., home network carrier). In some instances, the one or more communication channels can be associated with a telecommunications provider that provides services (e.g., 3G network, 4G network, LTE network, 5G network, NR, and the like) to user devices, such as UE(s) 102, 104, 106. For example, the one or more communication channels may provide voice, SMS, and/or data services to UE 102, 104, 106, or corresponding users that are registered or subscribed to utilize the services provided by the telecommunications service provider. The one or more communication channels can comprise, for example, a 1× circuit voice, a 3G network (e.g., CDMA, CDMA2000, WCDMA, GSM, UMTS), a 4G network (WiMAX, LTE, HSDPA), or a 5G network.

In some implementations, node 110 is configured to communicate with a UE, such as UE(s) 102, 104, 106 located within the geographic area, or cell, covered by radio antennas 112 of node 110. A node 110 may include one or more base stations, base transmitter stations, radios, antennas, antenna arrays, power amplifiers, transmitters/receivers, digital signal processors, control electronics, GPS equipment, and the like.

As shown, node 110 receives a signal from one of UE(s) 102, 104, 106 via antenna in radio 112. The signal may include a UE capability message from one of UE(s) 102, 104, 106 indicating a type of the UE. For example, the type of UE comprises one of: a home customer premises equipment (CPE), a fixed internet of things (IoT) sensor, or an Ultra-Reliable Low Latency Communications (URLLC) device.

Based on the type of UE, the node 110 executes a dynamic wireless network protocol. For example, UE 102 is a 6G device. Accordingly, the dynamic wireless network protocol executed by node 110 facilitates network registration and authentication information exchange with core network 120. In another example, UE 104 is a fixed wireless access device. Accordingly, the dynamic wireless network protocol executed by node 110 enables local authentication and a simplified protocol stack, where the core network 120 is not used. In yet another example, UE 106 is an IoT device. Accordingly, the dynamic wireless network protocol executed by node 110 enables local authentication and a simplified protocol stack, where there is only signaling but no user plane in core network 120.

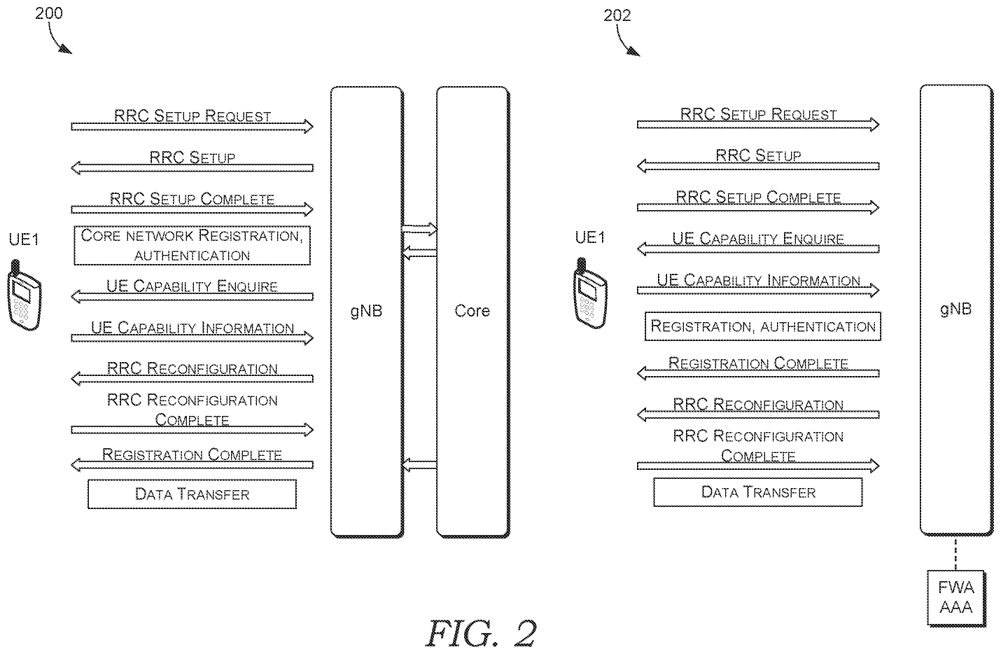

Turning to FIG. 2, examples of a static call flow 200 and a dynamic call flow 202 are illustrated, in accordance with aspects herein. As shown, in both the static call flow 200 and the dynamic call flow 202, the process begins with the UE communicating a radio resource control (RRC) setup request to the node. In response, the node communicates a RRC setup message to the UE which may include RRC parameters such as establishment cause, RRC configuration, and initial downlink radio resource configuration. The UE acknowledges the RRC setup message by sending a RRC setup complete message to the node indicating the UE has successfully configured the provided RRC parameters.

The processes deviate from here. In the static call flow 200, the node and the core network exchange network registration and authentication information. After this exchange, the node communicates a UE capability enquire message and the UE responds to the node with UE capability information. Next, the node communicates a RRC reconfiguration message to the UE and the UE responds with a RRC reconfiguration complete message. At this point, the core network communicates to the node and the node communicates to the UE that registration is complete and data transfer can begin between the UE and the core network via the node.

In contrast, and referring to the dynamic call flow 202, in situation where the core network is not needed, after the RRC setup is complete, the node communicates a UE capability enquire message and the UE responds to the node with UE capability information. At this point, registration and authentication information can be exchanged between the UE and the AAA via the node and the node communicates to the UE that registration is complete. Next, the node communicates a RRC reconfiguration message to the UE and the UE responds with a RRC reconfiguration complete message. Data transfer can begin between the UE and the node. In the dynamic call flow 202, the core network is bypassed.

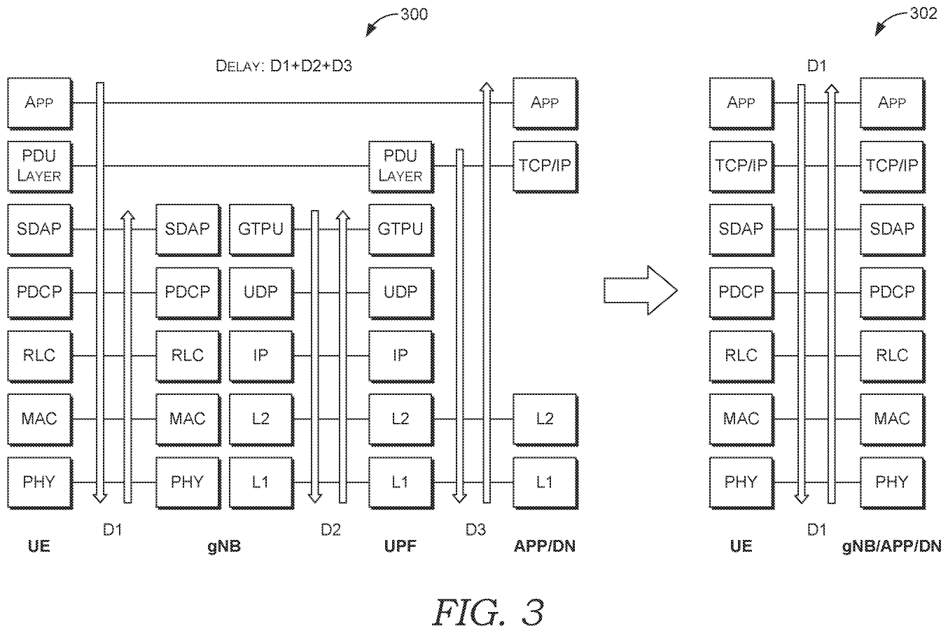

Referring now to FIG. 3, examples of a static protocol stack 300 and a dynamic protocol stack 302 are illustrated. As shown in example static protocol stack 300, delays occur in several instances. For example, there is a first delay D1 in communications between the UE and the node. There is a second delay D2 in communications between the node and the user plane function. Finally, there is s third delay D3 in communications between the user plane function and the application via data network.

In contrast, by utilizing dynamic network protocols, delays can be significantly reduced or bypassed by eliminating certain communications based on the type of UE. For example, as shown in the example dynamic protocol 302, the UE communicates directly with the node and the application via data network. In other words, the user plane function in the core network is bypassed and the ordinary delay corresponding to communications between the node and the user plane function, and the user plane function and the application via data network are eliminated.

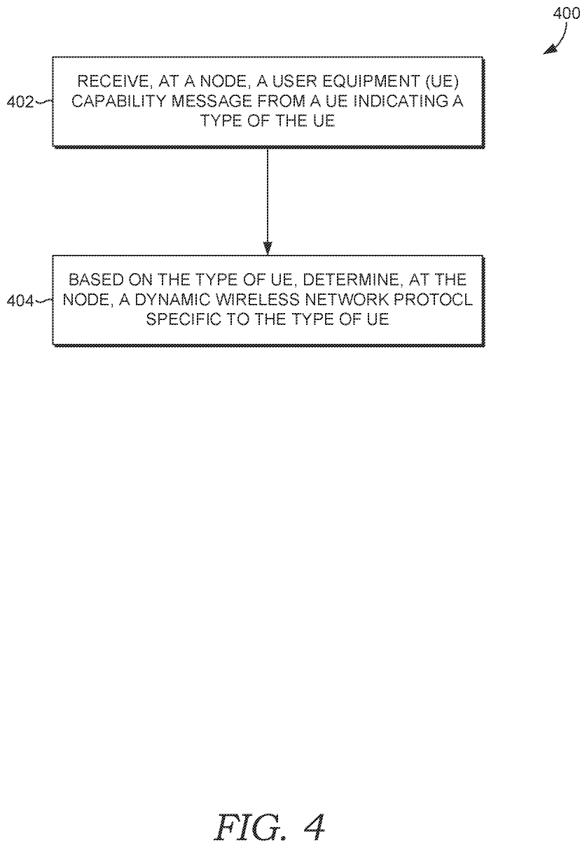

In FIG. 4, a flow diagram is provided depicting a method 400 for utilizing dynamic wireless network protocols, in accordance with aspects of the present invention. Method 400 may be performed by any computing device (such as computing device described with respect to FIG. 5) with access to a dynamic wireless network protocol system (such as the one described with respect to FIG. 1) or by one or more components of the dynamic wireless network protocol system described with respect to FIG. 1.

Initially, at step 402, a UE capability message from a UE is received at a node. The UE capability message indicates a type of the UE. For example the type of UE comprises one of: a home customer premises equipment (CPE), a fixed internet of things (IoT) sensor, an Ultra-Reliable Low Latency Communications (URLLC) device, or a 6G device.

In some aspects, the UE capability message comprises information elements. A first information element may indicate the version of the message structure. A second information element may contain the actual UE capability information. The second information element may comprise several sub information elements. For example, a first sub information element may include a list of UE capability containers for different radio access technologies (RATs). For example, the list of UE capability containers may comprise 5G New Radio (NR), Evolved UMTS Terrestrial Radio Access (E-UTRA), Universal Terrestrial Radio Access (UTRA), GSM EDGE Radio Access Network (GERAN), and Code Division Multiple Access 2000 (CDMA2000).

A second sub information element may include a list of UE capability protocol containers for different protocol support. For example, a Non-access stratum (NAS) protocol container may indicate that NAS is not supported for FWA devices but is supported for IoT devices. In another example, a Hybrid Automatic Repeat Request (HARQ) protocol container may indicate that HARQ is not supported for Ultra-Reliable Low Latency Communications (URLLC) devices. In yet another example, a user plane protocol container may indicate that the user plane is not supported for IoT devices (i.e., signaling only at the 6G core network). At step 404, based on the type of UE, a dynamic wireless network protocol specific to the type of UE is determined at the node.

At step 404, based on the type of UE, the node determines a dynamic wireless network protocol specific to the type of UE. In some aspects, based on the type of UE comprising a home CPE, the node initiates a dynamic wireless network protocol comprising local authentication. In some aspects, the dynamic wireless network protocol comprises no communications with the core network. Additionally or alternatively, the dynamic wireless network protocol comprises no user plane within the core network. In some aspects, based on the type of UE comprising an IoT device (or an IoT sensor), the node initiates a dynamic wireless network protocol comprising signaling only and no user plane or mobility within the core network. In some aspects, based on the type of UE comprising a URLLC device, the node initiates a dynamic wireless network protocol comprising no HARQ. In some aspects, based on the type of UE comprising a 6G device the node initiates a dynamic wireless network protocol comprising no radio link control (RLC) acknowledge mode (AM).

Embodiments of the technology described herein may be embodied as, among other things, a method, a system, or a computer-program product. Accordingly, the embodiments may take the form of a hardware embodiment, or an embodiment combining software and hardware. The present technology may take the form of a computer-program product that includes computer-useable instructions embodied on one or more computer-readable media. The present technology may further be implemented as hard-coded into the mechanical design of network components and/or may be built into a broadcast cell or central server.

Computer-readable media includes both volatile and non-volatile, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 5, a block diagram of an exemplary computing device 500 suitable for use in implementations of the technology described herein is provided. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated. It should be noted that although some components in FIG. 5 are shown in the singular, they may be plural. For example, the computing device 500 might include multiple processors or multiple radios. In aspects, the computing device 500 may be a UE/WCD, or other user device, capable of two-way wireless communications with an access point. Some non-limiting examples of the computing device 500 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 5, computing device 500 includes a bus 510 that directly or indirectly couples various components together, including memory 512, processor(s) 514, presentation component(s) 516 (if applicable), radio(s) 524, input/output (I/O) port(s) 518, input/output (I/O) component(s) 520, and power supply(s) 522. Although the components of FIG. 5 are shown with lines for the sake of clarity, in reality, delineating various components is not so clear, and metaphorically, the lines would more accurately be grey and fuzzy. For example, one may consider a presentation component such as a display device to be one of I/O components 520. Also, processors, such as one or more processors 514, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 512 may take the form of memory components described herein. Thus, further elaboration will not be provided here, but it should be noted that memory 512 may include any type of tangible medium that is capable of storing information, such as a database. A database may be any collection of records, data, and/or information. In one embodiment, memory 512 may include a set of embodied computer-executable instructions that, when executed, facilitate various functions or elements disclosed herein. These embodied instructions will variously be referred to as “instructions” or an “application” for short.

Processor 514 may actually be multiple processors that receive instructions and process them accordingly. Presentation component 516 may include a display, a speaker, and/or other components that may present information (e.g., a display, a screen, a lamp (LED), a graphical user interface (GUI), and/or even lighted keyboards) through visual, auditory, and/or other tactile cues.

Radio 524 represents a radio that facilitates communication with a wireless telecommunications network. Illustrative wireless telecommunications technologies include CDMA, GPRS, TDMA, GSM, and the like. Radio 524 might additionally or alternatively facilitate other types of wireless communications including Wi-Fi, WiMAX, LTE, 3G, 4G, LTE, mMIMO/5G, NR, VOLTE, or other VolP communications. As can be appreciated, in various embodiments, radio 524 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 518 may take a variety of forms. Exemplary I/O ports may include a USB jack, a stereo jack, an infrared port, a firewire port, other proprietary communications ports, and the like. Input/output (I/O) components 520 may comprise keyboards, microphones, speakers, touchscreens, and/or any other item usable to directly or indirectly input data into the computing device 500.

Power supply 522 may include batteries, fuel cells, and/or any other component that may act as a power source to supply power to the computing device 500 or to other network components, including through one or more electrical connections or couplings. Power supply 522 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

The invention claimed is:

1. One or more computer-readable media having computer-executable instructions embodied thereon that, when executed, perform a method of utilizing dynamic wireless network protocols, the method comprising:
receiving, at a node, a user equipment (UE) capability message from a UE indicating a type of the UE; and
based on the type of UE, determining, at the node, a dynamic wireless network protocol specific to the type of UE.

2. The media of claim 1, wherein the type of UE comprises one of: a home customer premises equipment (CPE), a fixed internet of things (IoT) sensor, or an Ultra-Reliable Low Latency Communications (URLLC) device.

3. The media of claim 1, further comprising, based on the type of UE comprising the home CPE, initiating, at the node, the dynamic wireless network protocol comprising local authentication.

4. The media of claim 3, wherein the dynamic wireless network protocol comprises no communications with a core network.

5. The media of claim 3, wherein the dynamic wireless network protocol comprises no user plane with a core network.

6. The media of claim 1, further comprising, based on the type of UE comprising the IoT sensor, initiating, at the node, the dynamic wireless network protocol comprising signaling only no user plane or mobility with a core network.

7. The media of claim 1, further comprising, based on the type of UE comprising the URLLC device, initiating, at the node, the dynamic wireless network protocol comprising no Hybrid Automatic Repeat Request (HARQ).

8. The media of claim 1, further comprising, based on the type of UE comprising a 6G device initiating, at the node, the dynamic wireless network protocol comprising no radio link control (RLC) acknowledge mode (AM).

9. A method of utilizing dynamic wireless network protocols, the method comprising:
receiving, at a node, a user equipment (UE) capability message from a UE indicating a type of the UE; and
based on the type of UE, determining, at the node, a dynamic wireless network protocol specific to the type of UE.

10. The method of claim 9, wherein the type of UE comprises one of: a home customer premises equipment (CPE), a fixed internet of things (IoT) sensor, or an Ultra-Reliable Low Latency Communications (URLLC) device.

11. The method of claim 9, further comprising, based on the type of UE comprising the home CPE, initiating, at the node, the dynamic wireless network protocol comprising local authentication.

12. The method of claim 11, wherein the dynamic wireless network protocol comprises no communications with a core network.

13. The method of claim 11, wherein the dynamic wireless network protocol comprises no user plane within a core network.

14. The method of claim 9, further comprising, based on the type of UE comprising the IoT sensor, initiating, at the node, the dynamic wireless network protocol comprising signaling only without a user plane being setup or mobility within a core network.

15. The method of claim 9, further comprising, based on the type of UE comprising the URLLC device, initiating, at the node, the dynamic wireless network protocol comprising no Hybrid Automatic Repeat Request (HARQ).

16. The method of claim 9, further comprising, based on the type of UE comprising a 6G device initiating, at the node, the dynamic wireless network protocol comprising no radio link control (RLC) acknowledge mode (AM).

17. A system for utilizing dynamic wireless network protocols, the system comprising:
a user equipment (UE); and
a node configured to wirelessly communicate with the UE, wherein the node is configured to:
receive a UE capability message from a UE indicating a type of the UE;
based on the type of UE, determining a dynamic wireless network protocol specific to the type of UE; and
initiate the dynamic wireless network protocol specific to the type of UE.

18. The system of claim 17, wherein the type of UE comprises one of a home customer premises equipment (CPE), a fixed internet of things (IoT) sensor, or an Ultra-Reliable Low Latency Communications (URLLC) device.

19. The system of claim 17, wherein the dynamic wireless network protocol for a home customer premises equipment (CPE) comprises local authentication at the node and no user plane within a core network.

20. The system of claim 17, wherein the dynamic wireless network protocol for an IoT sensor comprises signaling only with no user plane or mobility within a core network.
